(19) United States
(12) Patent Application Publication
(10) Pub. No.: US 2012/0173857 A1
(43) Pub. Date: Jul. 5, 2012

(54) OVER THE AIR APPLIANCE FIRMWARE UPDATE

(75) Inventors: Henry Nader Kobraei, Louisville, KY (US); John K. Besore, Prospect, KY (US); Robert Bultman, Louisville, KY (US); Timothy Worthington, Crestwood, KY (US); Michael F. Finch, Louisville, KY (US); Steven Root, Louisville, KY (US); Jeffrey Donald Drake, Louisville, KY (US)

(73) Assignee: General Electric Company

(21) Appl. No.: 12/980,473

(22) Filed: Dec. 29, 2010

(51) Int. Cl. G06F 9/24

(52) U.S. Cl. 713/2

(57) ABSTRACT

An appliance is placed in a bootload mode and other operations of the appliance are powered down. Data is gathered through an appliance control module which activates the bootloader mode, and then receives the data and overwrites the remainder of the appliance controller memory. In this manner, software for an appliance is updated without having to enter the home.

### BACKGROUND OF THE DISCLOSURE

The following disclosure relates to energy management, and more particularly to energy management of household consumer appliances. The present disclosure finds application in updating software or firmware associated with the appliance so that operation of the appliance can be updated without entering a home.

Presently, various home appliances (refrigerator, freezer, clothes washer, clothes dryer, cooking range, dishwasher, water heater, microwave, room air conditioner, etc.) include a control board for operating the particular appliance. If there is a need to update software, service technicians must enter the home and remove an old existing control board from the appliance. Oftentimes, the old control board is not easy to access and requires the appliance to be moved to open an access panel, e.g., provided on a rear surface or underside of an appliance. The new control board with new code or software is then installed and substituted for the old control board, the appliance access panel closed, and the appliance moved back into place.

In addition, there are times when the manufacturer would like to identify particular homeowners that own a certain model of an appliance, for example, for warranty or repair work. It would be desirable to search for and contact such appliance owners by a model or serial number. Moreover, it would be even more desirable to reach the appliance owner in a non-intrusive manner.

Consequently, a need exists for updating software associated with an appliance without having to enter a home and so that the software of that appliance can be remotely updated, and preferably through a wireless or over-the-air connection.

### SUMMARY OF THE DISCLOSURE

A new system and method of updating operation of an appliance is provided.

An appliance includes a microcontroller that operates the appliance and communicates with a memory that has a bootloader. A module is in operative communication with the appliance and configured to receive updated software, initiate the bootloader in the appliance microcontroller, and upload new software to the appliance memory.

In one arrangement, a separate module is provided for each appliance, and the appliance may be wired or the module(s) configured to exchange data wirelessly with the appliance microprocessor.

The system may further include a home energy manager that operatively interacts with the module to transfer the updated software to the module. The module initiates the bootloader and subsequently transfers the updated software to the appliance memory.

A preferred method of updating the firmware in an appliance includes initiating a bootloader of the operating software, and uploading portions of updated software to the memory.

The uploading step includes writing over old software stored in the memory.

The uploading step may include downloading through a utility meter, home energy manager, utility backhaul, internet, etc.

The uploading step includes passing multiple portions of the updated software to the appliance memory.

The method further comprises running the bootloader and powering down a majority of the operations of the appliance.

A primary benefit is the ability to eliminate the need for a service technician to enter a home to update software and operation of the appliance.

Still another benefit resides in the ability to check appliances for updates.

Still another advantage resides in the ability to seek appliances by model and serial number to initiate an update if desired.

Still other features and benefits of the present disclosure will become more apparent to those skilled in the art upon reading and understanding the following detailed description.

### BRIEF DESCRIPTION OF THE DRAWINGS

FIG. 1 is a schematic representation of an appliance software update system.

FIG. 2 is a flowchart representation of preferred steps in a method of updating the software for the appliances.

### DETAILED DESCRIPTION

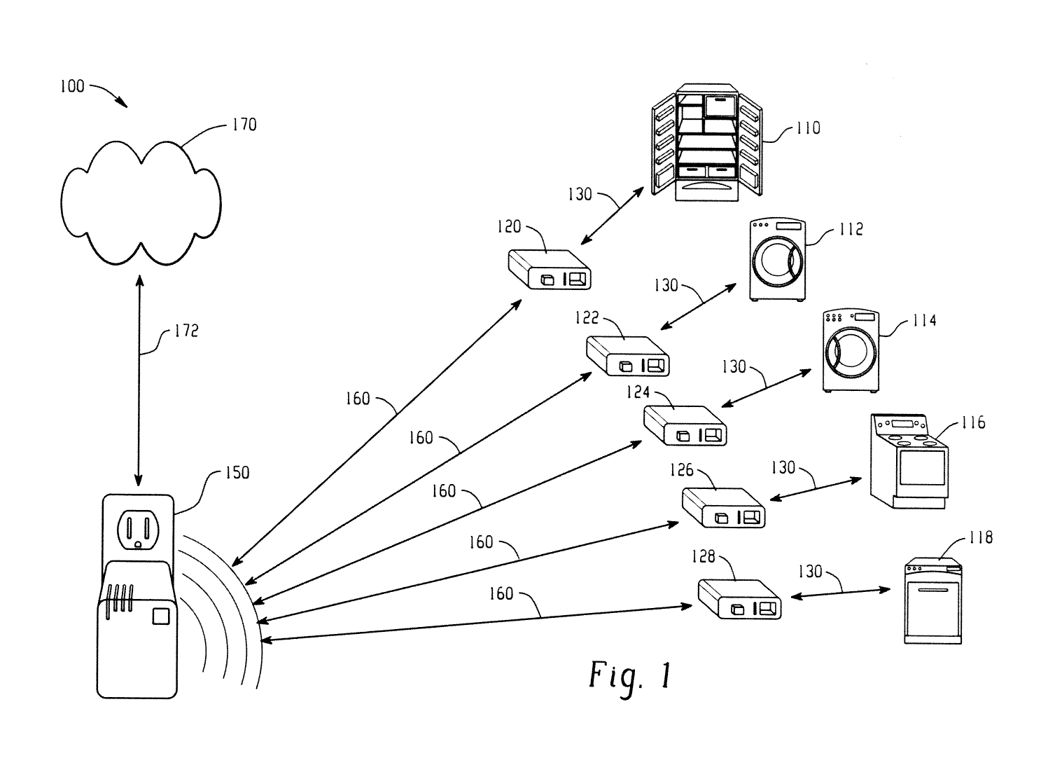

A more recent innovation with regard to appliance control is to use a control module associated with the appliance, or a module that is operatively associated with more than one appliance, e.g., a single module for a clothes washer and dryer. As referenced in FIG. 1, system 100 includes a number of different home appliances, such as a refrigerator/freezer 110, clothes washer 112, clothes dryer 114, range/stovetop 116, dishwasher 118, etc. Each of these appliances is shown with a respective control module 120, 122, 124, 126, and 128 (also occasionally referred to as demand response modules or appliance communication modules). As illustrated, the modules 120-128 are shown as separate components from the individual appliances 110-118, although one skilled in the art will recognize that this is a schematic representation and that the modules may be separate or incorporated into a housing of an individual appliance if desired. In any event, each module is configured to communicate (wired or wirelessly) with a respective appliance as represented by reference numerals 130. Further, the communication reference numeral is shown as a preferred two-way exchange of data or signals between the modules and the appliances.

In recently developed home energy management systems, one key to reducing energy consumption in homes and buildings includes having various utility companies communicate with home appliances, HVAC, water heaters, etc. in a home. One manner of implementing such a home energy management system uses a router/gateway arrangement 150 that collects information from appliances (which is generally representative of individual appliances, HVAC, pool pumps, etc.) and also communicates with the appliances 110-418 through the appliance communication modules 120-128 via a home appliance network 160 within the home and sends the data to a remote server 170 via local area network 172, for example. The home energy gateway (HEG) 150 is represented as a compact device that is small enough to be plugged into a standard wall outlet and therefore does not need space on a countertop, table top, and does not need to be attached to a wall or other surface. The HEG 150 in the illustrated embodiment does not have a separate display or keyboard and instead has computational capabilities and multiple communication technologies incorporated within the device. The HEG 150 is small, inexpensive, and consumes little power while providing the capability of operating over multiple communication networks. This allows the HEG 150 to acquire and manipulate data of one communication network 160, i.e., to receive information from the modules 120-128 (that, in turn, communicate with the appliances 110-118 through home area network 130), and supply data and signals as represented by communication path 172 with the remote server 170 of a utility company, for example. Thus, the HEG is connected to system loads such as the home appliances over one type of communication network, to a utility company over a different communication network, and perhaps to a display (not shown) over a third different communication network.

By way of example only, a Wi-Fi communication network is used to connect with a remote display, a ZigBee communication network is used for communication with the utility company over the meter, and a connection to the home device or appliance network and its individual modules through communication paths 160 over still another network referenced as a home appliance network (HAN).

As is evident from the schematic representation, each of the modules 120-128 is able to communicate with a respective appliance, whether this be through a wired connection or wirelessly, so that a microprocessor or controller in each of the appliances receives data signals that may impact operation of one or more of the appliances, for example in response to a peak demand signal. Operation of one or more of the appliances may be altered by the controllers from a mere on/off switching to more complex control of the operation of one or more of the appliances depending on potential cost savings that can be achieved.

Today, appliances do not have real time operating systems. Therefore, if an update or a new software portion is required, an effective manner of uploading new software updates is required. One preferred manner of doing this is to use a bootload-type of mode. That is, the controller or microprocessor associated with each appliance includes a memory or storage portion in which a bootloader resides. Typically, the bootloader program only uses a small amount of the total memory, e.g., less than five percent (5%), perhaps approximately three percent (3%) of the total memory. Either a home energy manager or home energy gateway would be addressed when an update for an appliance is required. For example, an algorithm is established that searches for appliances that need updating. This prompts a user whether to update the software associated with one or more of the appliances. Use of an interne connection offers one possibility for establishing the communication through the home energy manager or home energy gateway. The demand supply or appliance communication modules 120-128 are tethered to the appliances so that bytes could be transferred in and bytes transferred out, and each module simply acts as a “middle-man” or transfer point to pass the information from the gateway or manager to the appliances. The data or information preferably works with flash data on the appliance and can also be programmed so that the flash data is updated at a convenient time, for example in the middle of the night when the appliance may not be in use.

The bootloader sector of the appliance controller is activated, that is, the particular modules 120-128 will know how to initiate the bootloader mode in the appliances in response to the module(s) receiving an appropriate signal. Once a command signal is received by the module(s), the module(s) will contact one or more of the appliances and puts each appliance into a bootload mode. Most other operations of the appliance are likely powered down during the bootload operation and instead the memory waits to receive bytes of information to overwrite the remainder of the flash memory.

It will be appreciated that the home energy gateway may have no understanding of what the information or data is that is being transferred, but the home energy gateway and the module are simply passing the information along. The bootloader associated with each appliance, on the other hand, will know that a particular byte of information goes to a particular location in the memory and thus transfers the information into the appliance memory as it is received. It may be that the module does not even copy and paste the information but simply transfers or passes the data along, for example in a sequential passing operation.

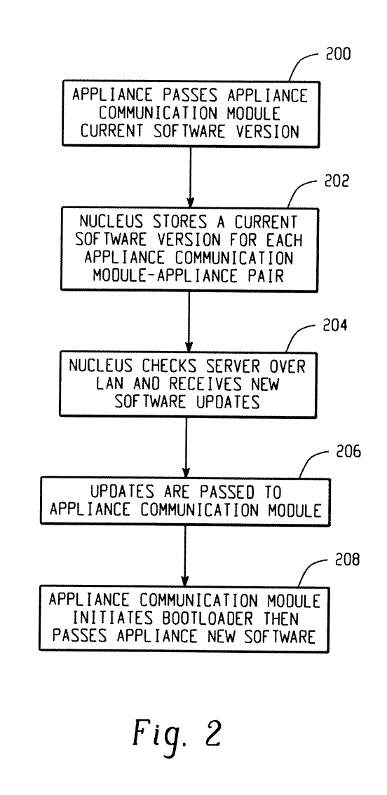

Thus, as represented in flowchart form in FIG. 2, the appliance passes information via the appliance communication modules (120-128) regarding the current software version (200). A bootloader or nucleus portion of the memory stores the current software version for each appliance communication module (202). The nucleus checks the server over the local area network and receives new software updates (204). These updates are then passed to the appliance communication modules 120-128 over the home appliance network 170 (206). In turn, each appliance communication module initiates the bootloader and passes the appliance 110-118 the new software (208). Again, the connection between the module and the appliances could be wired or could be a wireless communication.

One skilled in the art will likewise recognize that EEPROM values could be similarly updated over. the air. In such an instance, the bootload mode would not be required. Instead, updated EEPROM values or data could be passed over the air, and then the appliance control module(s) would send a command with the data to the appliance control to write new EEPROM values.

In summary, the data is received through a utility back haul, interne, or other connection and the data loaded to an appliance or appliance communication module which uploads the data into the appliance controller. A user can also initiate software updates through an appliance user interface, home energy gateway, home energy manager, or home energy controller, or may possibly institute the action by calling the utility company. The upload can also be initiated as part of a diagnostic mode or by a call taker in a customer service center. This offers a way to update the appliance software without entering the home. The present system also allows the appliances to be interrogated to seek out an update those appliances that require an update. For example, there is the ability to check for updates and also to seek appliances by model and serial number and subsequently initiate an update if needed. The bootloader portion of the memory is listening and gathering data, and overwriting the other major portion of the memory. Of course, the appliance has to be preset to be able to perform this operation and typically upon a re-start, the appliance is then operating on the next version of the software.

The disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. A method of updating firmware in an appliance having memory which includes operating software stored therein that controls operation of the appliance, the method comprising:
initiating a bootloader of the operating software; and
uploading at least portions of updated software to the memory.

2. The method of claim 1 wherein the uploading step includes writing over old software stored in the memory.

3. The method of claim 1 wherein the uploading step includes downloading through a utility meter.

4. The method of claim 1 wherein the uploading step includes downloading the updated software through a home energy manager external of the appliance.

5. The method of claim 1 wherein the initiating step includes accessing an appliance user interface to begin the updated software uploading.

6. The method of claim 1 wherein the uploading step includes using a utility backhaul for transferring the updated software to the memory.

7. The method of claim 1 further comprising using a wireless internet connection for uploading the updated software.

8. The method of claim 1 wherein the uploading step includes passing multiple portions of the updated software to the appliance memory.

9. The method of claim 1 further comprising running the bootloader that includes powering down a majority of the operations of the appliance, and the bootloader receiving updated software which is then written to the appliance memory.

10. The method of claim 1 further comprising updating EEPROM values over air.

11. A system that updates firmware in an appliance having memory which includes operating software stored therein that controls operation of the appliance, the system comprising:
an appliance that includes a microcontroller that operates the appliance and communicates with a memory that includes a bootloader;
a module in operative communication with the appliance and configured to receive updated software, initiate the bootloader, and upload the updated software to the appliance memory.

12. The system of claim 11 further comprising a separate module for each appliance.

13. The system of claim 11 wherein the appliance is wired to the module.

14. The system of claim 11 wherein the appliance and the module exchange data wirelessly.

15. The system of claim 11 further comprising a home energy manager that receives a notification from an associated remote source that the updated software is available.

16. The system of claim 15 wherein the home energy manager targets a particular appliance in response to receiving the updated software notification.

17. The system of claim 16 wherein the home energy manager operatively interacts with the module to transfer the updated software to the module.

18. The system of claim 17 wherein the module initiates the bootloader and subsequently transfers the updated software to the appliance memory.

19. The system of claim 17 further comprising a main memory in selective communication with an associated remote server and in further communication with the module, the main memory storing a current version of the software for each appliance.
